(19) United States
(12) Patent Application Publication
(10) Pub. No.: US 2013/0313821 A1
(43) Pub. Date: Nov. 28, 2013

(54) U-BEND FITTING

(71) Applicant: Phoenix Geothermal Services, LLC, Auburn, NY (US)

(72) Inventors: John Douglas Manning, Auburn, NY (US); Jared Paul Fortna, Ithaca, NY (US); Mitchell Louis Conklin, Moravia, NY (US); Ron Abraham Gershoni, San Diego, CA (US); Danny Gershoni, Closter, NJ (US)

(21) Appl. No.: 13/900,795

(22) Filed: May 23, 2013

Related U.S. Application Data
(60) Provisional application No. 61/651,825, filed on May 25, 2012.

(51) Int. Cl. F16L 43/00

(52) U.S. Cl. CPC F16L 43/00
USPC 285/134.1

(57) ABSTRACT

A U-bend fitting for connecting a first pipe and a second pipe, e.g., in cooling pipe system for an ice rink, is disclosed. The U-bend fitting includes a first collar, a second collar, and a curved hollow body forming a fluid path configured to allow fluid to flow from the first pipe to the second pipe. In one embodiment, the U-bend fitting includes a brace extending transversely between the first collar and the second collar, the brace configured to resist movement of the first collar toward the second collar. In another embodiment, the U-bend fitting includes a concave channel extending longitudinally along at least a portion of the outer surface of the curved hollow body. The concave channel is configured for receiving a curved surface of a support to which the outer surface of the curved hollow body can be tied.

### CROSS-REFERENCE TO RELATED APPLICATIONS

This application claims the benefit of and priority to U.S. Provisional Patent Application Ser. No. 61/651,825, filed May 25, 2012, and entitled “U-BEND FITTING FOR ICE RINKS,” the entirety of which is incorporated herein by reference.

### BACKGROUND OF THE INVENTION

The subject matter disclosed herein relates to U-bend fittings, including fittings used in cooling pipe systems for ice rinks.

Cooling pipe systems for ice rinks circulate a coolant (e.g., anti-freeze, refrigerant, etc.) through a piping system that is encased in concrete or sand, which is cooled by the heat transfer between the coolant circulated through the pipes. The temperature of the concrete or sand can be lowered sufficiently to form and maintain ice on the surface of the concrete or sand.

A conventional U-bend fitting for an ice rink uses two 90 degree elbows and a straight piece of pipe as part of a cooling pipe system. The first elbow receives the coolant from the first conduit and transitions the coolant through a straight pipe, which is attached to the second elbow, which transitions the coolant into the second conduit. The U-bend fitting is supported at the edge of the ice rink using a hose clamp or similar fastener that ties the U-bend fitting to a support extending along the perimeter of the ice rink. This U-bend fitting presents a number of disadvantages. First, since the U-bend fitting is made of multiple components (e.g., first elbow, second elbow, and straight pipe), the assembly of the U-bend fitting can be time consuming. Second, the increased thickness of the walls of the elbows produces less efficient and effective heat transfer from the coolant to the concrete or sand, producing less cooling along the perimeter of the ice rink, where the ice is already most susceptible to melting under increased heat conditions. Third, in part, because of the poor heat transfer resulting from the U-bend fitting, in addition to cooling pipes traversing the length or width of the ice rink, an additional perimeter cooling pipe loop is required along the perimeter. Fourth, since the U-bend fitting does not have any additional protection on its outer surface, the hose clamps used to tie the U-bend fitting can damage the elbows or straight pipe. Finally, the U-bend fitting can be susceptible to damage or separation based on the thermal expansion and/or contraction of the cooling pipes during installation or during the curing of the concrete.

In another conventional U-bend fitting for an ice rink, a straight piece of conduit can be heated and bent with a mandrel into the desired shape. This U-bend fitting presents a number of disadvantages. First, since the U-bend fitting must be made from a straight piece of conduit that must be heated and then bent, the assembly of the U-bend fitting can be time consuming. Second, since the straight piece of pipe is typically provided with a thicker wall to ensure sufficient thickness after the bending of the pipe, the increased thickness of the wall produces less efficient and effective heat transfer from the coolant to the concrete or sand.

The discussion above is merely provided for general background information and is not intended to be used as an aid in determining the scope of the claimed subject matter.

### BRIEF DESCRIPTION OF THE INVENTION

A U-bend fitting for connecting a first pipe and a second pipe, e.g., in cooling pipe system for an ice rink, is disclosed. The U-bend fitting includes a first collar, a second collar, and a curved hollow body forming a fluid path configured to allow fluid to flow from the first pipe to the second pipe. In one embodiment, the U-bend fitting includes a brace extending transversely between the first collar and the second collar, the brace configured to resist movement of the first collar toward the second collar. In another embodiment, the U-bend fitting includes a concave channel extending longitudinally along at least a portion of the outer surface of the curved hollow body. The concave channel is configured for receiving a curved surface of a support to which the outer surface of the curved hollow body can be tied.

In one embodiment, a U-bend fitting for connecting a first pipe and a second pipe, wherein the first pipe extends substantially parallel to the second pipe, is disclosed. The U-bend fitting comprises a first collar having an inner surface and an outer surface, the first collar configured for connecting the first pipe to the U-bend fitting, a second collar having an inner surface and an outer surface, the second collar configured for connecting the second pipe to the U-bend fitting, a curved hollow body having an inner surface and an outer surface, the curved hollow body extending from the first collar to the second collar, a flow path formed by the inner surfaces of the first collar, the curved hollow body, and the second collar, the flow path configured to allow fluid to flow from the first pipe to the second pipe, and a brace extending transversely between the outer surface of the first collar and the outer surface of the second collar, the brace configured to resist movement of the first collar toward the second collar that would bend the curved hollow body.

In another embodiment, the U-bend fitting comprises a concave channel extending longitudinally along at least a portion of the outer surface of the curved hollow body, the concave channel is configured for receiving a curved surface of a support to which the outer surface of the curved hollow body can be tied.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts a top view of an exemplary U-bend fitting as part of a cooling pipe system for an ice rink;

FIG. 2 is a cross-sectional view along section 2-2 of the exemplary U-bend fitting of FIG. 1; and

FIG. 3 is a cross-sectional view along section 3-3 of the exemplary U-bend fitting of FIG. 1.

### DESCRIPTION OF THE INVENTION

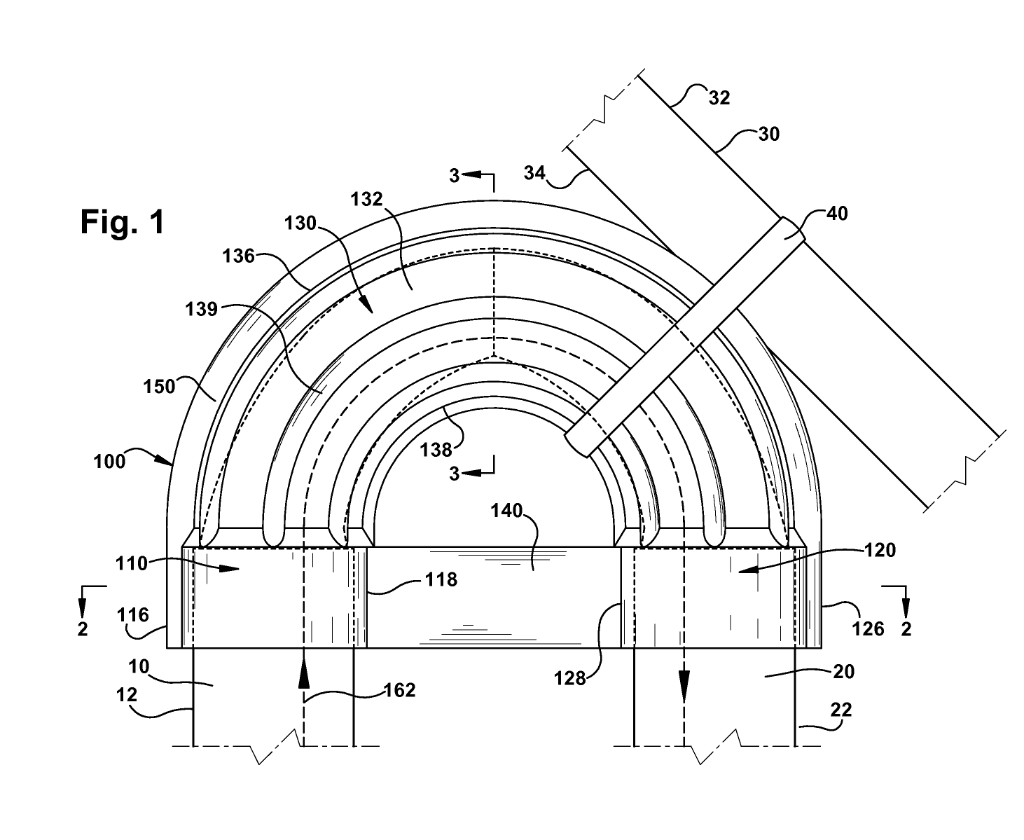

FIGS. 1-3 depict a top view and cross sectional views of an exemplary U-bend fitting 100 as part of a cooling system for an ice rink. The U-bend fitting 100 connects a first pipe 10 and a second pipe 20, wherein the first pipe 10 extends substantially parallel to the second pipe 20. The first pipe 10 has an outer surface 12 and an inner surface 14, while the second pipe 20 has an outer surface 22 and an inner surface 24. As shown in FIG. 1, the U-bend fitting 100 can be supported at the edge of the ice rink using a tie 40 (e.g., hose clamp, nylon tie, or similar fastener) that extends around the U-bend fitting 100 and the outer edge 32 of a support 30 (e.g., rebar, pipe with coolant, etc.) extending along the perimeter of the ice rink. As will be described, the U-bend fitting 100 transitions the fluid (coolant) 162 from the first pipe 10 to the second pipe 20 along a flow path 160.

In one embodiment, the U-bend fitting 100 comprises a first collar 110 configured for connecting the first pipe 10 to the U-bend fitting 100, a second collar 120 configured for connecting the second pipe 20 to the U-bend fitting 100, and a curved hollow body 130 extending from the first collar 110 to the second collar 120. In the exemplary embodiment shown in FIGS. 1-3, the curved hollow body 130 is integral with the first collar 110 and the second collar 120 and forms a U-shape. The curved hollow body 130 has an outer radial portion 136 and an inner radial portion 138. In alternative embodiments, the first collar 110, the second collar 120, and the curved hollow body 130 of the U-bend fitting 100 can form a curved shape other than a U-shape (e.g., a C-shape).

In one embodiment, the inner surface 114 of the first collar 110 receives the outer surface 12 of the first pipe 10, while the inner surface 124 of the second collar 120 receives the outer surface 22 of the second pipe 20. In another embodiment, the first collar 110 can be fused to the first pipe 10 and the second collar 120 can be fused to the second pipe 20. A flow path 160 through the U-bend fitting 100 is formed by the inner surface 114 of the first collar 110, the inner surface 134 of the curved hollow body 130, and the inner surface 124 of the second collar 114. The flow path 160 is configured to allow fluid 162 to flow from the first pipe 10 to the second pipe 20.

In one embodiment, a plurality of ribs 139 extend longitudinally along at least a portion of the outer surface 132 of the curved hollow body 130 of the U-bend fitting 100. By improving the strength of the walls of the U-bend fitting 100, the ribs 139 can, in some embodiments, allow for a thinner wall for the curved hollow body 130, which can improve heat transfer. In addition, the ribs 139 can improve the heat transfer by increasing the surface area that contacts the concrete or sand. The ribs 139 can also provide additional anchoring of the U-bend fitting 100 in the concrete or sand. The ribs 139 can also provide additional protection of the curved hollow body 130 from any damage that may be caused by the tie 40.

Because the exemplary U-bend fitting 100 is an integral piece, the U-bend fitting 100 is easier and quicker to install than conventional U-bend fittings that have multiple components. In addition, because the wall of the U-bend fitting 100 is thinner than conventional U-bend fittings, the heat transfer provided by the U-bend fitting 100 is more efficient and effective. This can increase the cooling at the perimeter of the ice rink, minimizing or potentially eliminating the need for a perimeter cooling pipe. In one embodiment, the U-bend fitting 100 is made from high-density polyethylene (HDPE), although other suitable materials (e.g., PVC) can be used.

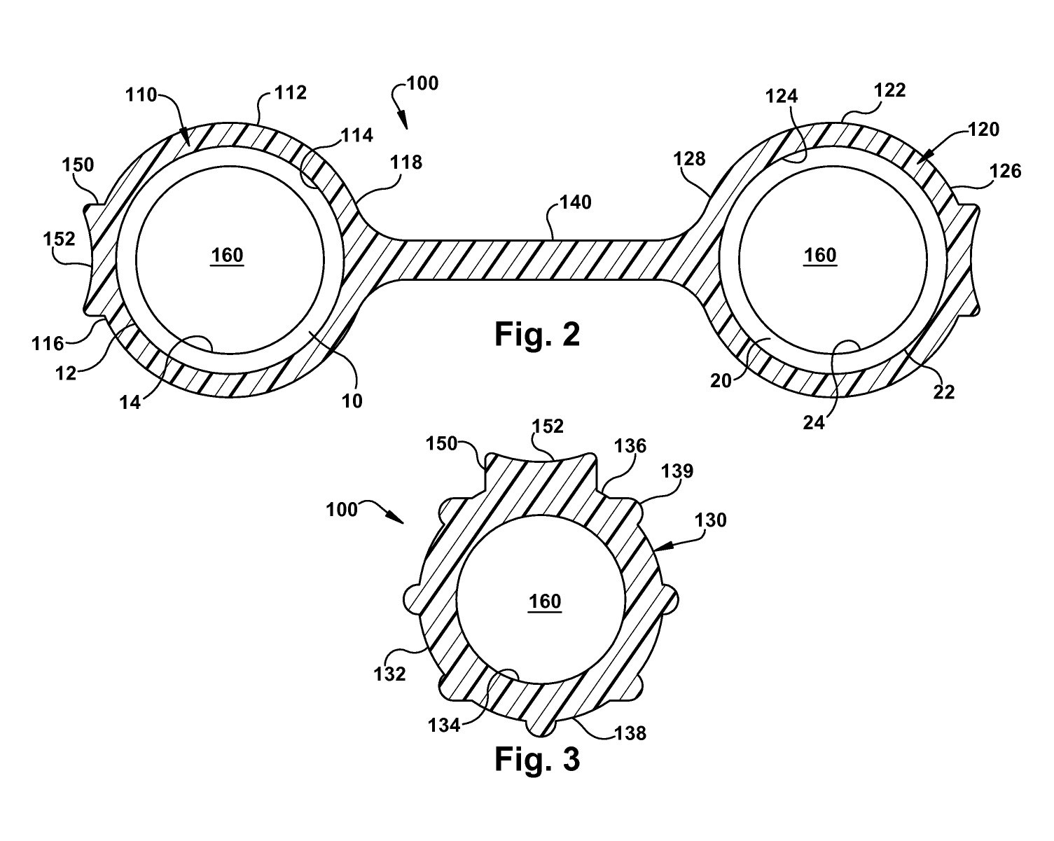

In one embodiment, and as best shown in FIGS. 1-2, the U-bend fitting 100 comprises a brace 140 extending transversely between the outer surface 112 of the first collar 110 and the outer surface 122 of the second collar 120. The brace extends between an inner radial portion 118 of the first collar 110 and an inner radial portion 128 of the second collar 120. In the exemplary embodiment, the brace 140 is integral with the first collar 110 and the second collar 120.

The brace 140 is configured to resist movement of the first collar 110 toward the second collar 120 that would bend (e.g., kink) the curved hollow body 130. This brace 140 prevents damage to the U-bend fitting 100 or the cooling pipe system caused by thermal expansion and/or contraction of the cooling pipes during installation and the curing of the concrete. For example, if the first pipe 10 and the second pipe 20 contract, exerting a pulling force on the U-bend fitting 100 away from the support 30, the U-bend fitting 100 might bend at the point where the tie 40 is located. This bending is resisted or prevented by the brace 140 between the first collar 110 and the second collar 120.

In one embodiment, the U-bend fitting 100 comprises a protrusion 150 extending longitudinally along at least a portion of the outer surface 132 of the curved hollow body 130. The protrusion 150 extends longitudinally along an outer radial portion 136 of the curved hollow body 130. In the exemplary embodiment, the protrusion 150 extends longitudinally along the outer radial portion 116 of the first collar 110, the outer radial portion 126 of the second collar 120, and the outer radial portion 136 of the curved hollow body 130. The protrusion 150 comprises a concave channel 152 configured for receiving a curved surface (e.g., inner edge 34) of the support 30 to which the outer surface 132 of the curved hollow body 130 can be tied. This concave channel 152 allows the U-bend fitting 100 to mate with the support 30 to provide additional securing and alignment of the U-bend fitting 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A U-bend fitting for connecting a first pipe and a second pipe, wherein the first pipe extends substantially parallel to the second pipe, the U-bend fitting comprising:
a first collar having an inner surface and an outer surface, the first collar configured for connecting the first pipe to the U-bend fitting;
a second collar having an inner surface and an outer surface, the second collar configured for connecting the second pipe to the U-bend fitting;
a curved hollow body having an inner surface and an outer surface, the curved hollow body extending from the first collar to the second collar;
a flow path formed by the inner surfaces of the first collar, the curved hollow body, and the second collar, the flow path configured to allow fluid to flow from the first pipe to the second pipe; and
a brace extending transversely between the outer surface of the first collar and the outer surface of the second collar, the brace configured to resist movement of the first collar toward the second collar that would bend the curved hollow body.

2. The U-bend fitting of claim 1, further comprising a plurality of ribs extending longitudinally along at least a portion of the outer surface of the curved hollow body.

3. The U-bend fitting of claim 1, wherein the curved hollow body is integral with the first collar and the second collar.

4. The U-bend fitting of claim 1, wherein the first collar, the curved hollow body, and the second collar form a U-shape.

5. The U-bend fitting of claim 1, wherein the brace extends between an inner radial portion of the first collar and an inner radial portion of the second collar.

6. The U-bend fitting of claim 1, wherein the brace is integral with the first collar and the second collar.

7. The U-bend fitting of claim 1, further comprising a concave channel extending longitudinally along at least a portion of the outer surface of the curved hollow body, the concave channel is configured for receiving a curved surface of a support to which the outer surface of the curved hollow body can be tied.

8. The U-bend fitting of claim 7, wherein the concave channel extends longitudinally along an outer radial portion of the curved hollow body.

9. A U-bend fitting for connecting a first pipe and a second pipe, wherein the first pipe extends substantially parallel to the second pipe, the U-bend fitting comprising:
a first collar having an inner surface and an outer surface, the first collar configured for connecting the first pipe to the U-bend fitting;
a second collar having an inner surface and an outer surface, the second collar configured for connecting the second pipe to the U-bend fitting;
a curved hollow body having an inner surface and an outer surface, the curved hollow body extending from the first collar to the second collar;
a flow path formed by the inner surfaces of the first collar, the curved hollow body, and the second collar configured to allow fluid to flow from the first pipe to the second pipe; and
a concave channel extending longitudinally along at least a portion of the outer surface of the curved hollow body, the concave channel is configured for receiving a curved surface of a support to which the outer surface of the curved hollow body can be tied.

10. The U-bend fitting of claim 9, further comprising a plurality of ribs extending longitudinally along at least a portion of the outer surface of the curved hollow body.

11. The U-bend fitting of claim 9, wherein the curved hollow body is integral with the first collar and the second collar.

12. The U-bend fitting of claim 9, wherein the first collar, the curved hollow body, and the second collar form a U-shape.

13. The U-bend fitting of claim 9, wherein the concave channel extends longitudinally along an outer radial portion of the curved hollow body.

14. The U-bend fitting of claim 9, further comprising a brace extending transversely between the outer surface of the first collar and the outer surface of the second collar, the brace configured to resist movement of the first collar toward the second collar that would bend the curved hollow body.

15. The U-bend fitting of claim 14, wherein the brace extends between an inner radial portion of the first collar and an inner radial portion of the second collar.

16. The U-bend fitting of claim 14, wherein the brace is integral with the first collar and the second collar.

17. A U-bend fitting for connecting a first pipe and a second pipe, wherein the first pipe extends substantially parallel to the second pipe, the U-bend fitting comprising:
a first collar having an inner surface and an outer surface, the first collar configured for connecting the first pipe to the U-bend fitting;
a second collar having an inner surface and an outer surface, the second collar configured for connecting the second pipe to the U-bend fitting;
a curved hollow body having an inner surface and an outer surface, the curved hollow body extending from the first collar to the second collar;
a flow path formed by the inner surfaces of the first collar, the curved hollow body, and the second collar configured to allow fluid to flow from the first pipe to the second pipe;
a brace extending transversely between the outer surface of the first collar and the outer surface of the second collar, the brace configured to resist movement of the first collar toward the second collar that would bend the curved hollow body; and
a concave channel extending longitudinally along at least a portion of the outer surface of the curved hollow body, the concave channel configured for receiving a curved surface of a support to which the outer surface of the curved hollow body can be tied.

18. The U-bend fitting of claim 17, further comprising a plurality of ribs extending longitudinally along at least a portion of the outer surface of the curved hollow body.

19. The U-bend fitting of claim 17, wherein the curved hollow body is integral with the first collar and the second collar.

20. The U-bend fitting of claim 17, wherein the first collar, the curved hollow body, and the second collar form a U-shape.

21. The U-bend fitting of claim 17, wherein the brace extends between an inner radial portion of the first collar and an inner radial portion of the second collar.

22. The U-bend fitting of claim 17, wherein the brace is integral with the first collar and the second collar.

23. The U-bend fitting of claim 17, wherein the concave channel extends longitudinally along an outer radial portion of the curved hollow body.
